(19) United States
(12) Patent Application Publication
(10) Pub. No.: US 2016/0344987 A1
(43) Pub. Date: Nov. 24, 2016

(54) Special Environment Projection System

(71) Applicant: Babak Taherloo, Ballerup (DK)

(72) Inventor: Babak Taherloo, Ballerup (DK)

(21) Appl. No.: 14/718,121

(22) Filed: May 21, 2015

(51) Int. Cl. H04N 9/31

(52) U.S. Cl. CPC H04N 9/3141; H04N 9/3194

(57) ABSTRACT

The present invention relates to a projection system that can display images to a non standard surface and surfaces in non standard environments

Due to various non flat projection surfaces and the desire to project on more surfaces from the same projection source and further to able projection under demanding environments such as very short distance, extreme sunlight, etc. the present invention relates to a projection system that introduces use of special combination of mirrors, lenses, cameras, projectors, screens, sensors that can be adapted mechanically, physically and by software project under before circumstances not possible and to create an optimal projection output.

### FIELD OF THE INVENTION

The present invention relates to a projection system that can display images to a non standard surface and surfaces in non standard environments

### BACKGROUND OF INVENTION

Due to various non flat projection surfaces and the desire to project on more surfaces from the same projection source and further to able projection under demanding environments such as very short distance, extreme sunlight, etc. the present invention relates to a projection system that introduces use of special combination of mirrors, lenses, cameras, projectors, screens, sensors that can be adapted mechanically, physically and by software to create an optimal projection output.

The projector system that is presented in this invention can project visual projections on surfaces that are located inside and outside and in various environmental locations and conditions.

It is desirable to project visual media in many places. Many physical factors such as i.e. screen size, distance from projector to screen, flexibility and output size and projectors area of facilitation, and environmental conditions that the projections have to overcome are becoming increasingly important.

Also the ability to tailor specific media towards audience is important.

### SUMMARY OF THE INVENTION

The projection system introduces have special features that will be described below.

The projection system have several different components that can be combined to achieve the optimal visual output under the physical and environmental circumstances that are demanding an alternative way to project.

The projector system is that the projectors visual projection don't require to be clear directly from the projectors lens output, but rather that it if can adapt all the area the light of the projector covers and computed how to ensure that the area that is covered with light becomes clear and visual optimal by assisting the projectors with additional features.

A computer will calculate an adaption of the area that is projected onto with attention to the surfaces, viewers, environmental conditions etc. and generate the physical and digital alterations required to produce an even and clear visible image.

Multiple projectors projecting from different angles and different positions with towards creating the same visual output allows avoiding dark or shadows areas.

Another projection system introduced in this invention is a digital micro mirror device chip i.e. DLP Chip (digital light processor chip) that can be adapted to fit existing light sources such as Light Bulbs, flash lights, etc. to function as a projectors.

For all the projection types introduced in the present invention, a method that allows projections in sunlight, direct sunlight our high lux environments is introduced.

This is done by allowing the sunlight or existing light in the environment of the projection or on the surface of the projection area, to be directed to either the projection digital light processor chip using with or without the help of other system components brought forth in the present projection system such as mirrors or lenses, in order to create clear and visible image in high light or sunlight environments.

This allows i.e. direct sunlight hitting the surface of a partculiar area of projection to be gathered and sent through the projectors digital light processor chip or an external digital light processor chip to create a stronger, brighter and more clear visual output in those environments and conditions.

Sensors such as light sensors, camera and other sensors and GPS and geographical data can help computer calculate how to achieve optimal visual output.

### BRIEF DESCRIPTION OF THE DRAWINGS

FIG. 1 illustrates Mounted Projector projecting to area of projection.

FIG. 2 illustrates Mounted Projector projecting to area of projection, and illustrates FIG. 1 from a front perspective.

FIG. 3 illustrates Multiple projectors and mirrors/lenses to cover larger Projection area.

FIG. 4 illustrates Multiple projectors and mirrors/lenses to cover larger Projection area, and illustrates FIG. 3 from a front perspective.

FIG. 5 illustrates shades enhancing a projections visibility.

FIG. 6 illustrates Projectors projecting onto specified patterns in the projections area.

FIG. 7 illustrates Projectors projecting onto specified patterns in the projections area. Illustrates FIG. 6 from a front perspective.

FIG. 8 illustrates Projector with a lens harnessing environmental light as a source for projection.

FIG. 9 illustrates Projector with a lens harnessing environmental light as a source for projection, and illustrates FIG. 8 from a front perspective.

FIG. 10 illustrates Projector being adjusted with a chip.

FIG. 11 illustrates Projector being adjusted with a chip, and illustrates FIG. 10 from a front perspective.

FIG. 12 illustrates Projector distributing its projection to more multiple surfaces in 360 degrees (all angles).

FIG. 13 illustrates Projector distributing its projection to more multiple surfaces using lenses/mirrors to increase area of projection.

FIG. 14 illustrates a projection system that interacts with users.

### DESCRIPTION OF THE PREFERRED EMBODIMENTS

The projection system contains following components:

Projector(s)

The projectors are either installed fix or mounted to viewer or viewer tools.

One or more projectors that project one or more images.

These projectors can be controlled to change angles based on the desired projection Projectors can be adjusted to project in all angles be adapted in all coordinated (X,Y,Z) that can be determined or adapted for optimal projection or by preprogramming from the computer or central server based or chosen be viewer, and determines with the computer which components to utilize and how to adapt the system components to achieve optimal visual output.

Mirror(s)

To enhance the projection from the projectors and direct the projections in the right direction to the desired surface to achieve desired distribution of projections

These mirrors can be controlled to change angles based on the desired projection.

Mirrors position in all angles be adapted in all coordinated (X,Y,Z) that can be determined or adapted for optimal projection or by preprogramming from the computer or central server based or chosen be viewer, and determines with the computer which components to utilize and how to adapt the system components to achieve optimal visual output.

Lens(es)

To enhance the projection from the projectors and direct the projections in the right direction to the desired surface to achieve desired distribution of projections

These lenses can be controlled to change angles based on the desired projection

Lenses position in all angles be adapted in all coordinated (X,Y,Z) that can be determined or adapted for optimal projection or by preprogramming from the computer or central server based or chosen be viewer, and determines with the computer which components to utilize and how to adapt the system components to achieve optimal visual output.

Environment Light Harnessing Lens

This is done by allowing the sunlight or existing light in the environment of the projection or on the surface of the projection area, to be directed to either the projection digital light processor chip using with or without the help of other system components brought forth in the present projection system such as mirrors or lenses, in order to create clear and visible image in high light or sunlight environments.

These shades can be controlled to change angles based on the desired projection

These environmental light harnessing lenses can be positioned in all angles and be adapted in all coordinated (X,Y,Z) that can be determined or adapted for optimal projection or by preprogramming from the computer or central server based or chosen be viewer, and determines with the computer which components to utilize and how to adapt the system components to achieve optimal visual output.

Cone/Multifaceted External Lenses

Multi facted lenses allows the distribution of the visual output in 360 Degrees in all 3 dimensions.

To enhance the projection from the projectors and direct the projections in 360 Degrees in all 3 dimensions special multifacted or coneshaped lenses are working with the projector.

These Cone/multifaceted external Lenses can be controlled to change angles and shape based on the desired projection.

The angles and shapes can be determined or adapted for optimal projection or by preprogramming from the computer or central server based or chosen be viewer, and determines with the computer which components to utilize and how to adapt the system components to achieve optimal visual output.

Receivers/Transmitters

Receivers/transmitters links together system components (sensors, projectors, lenses, mirrors, screens, shades, etc. to determine with the computer what media is best suitable and which components to utilize and how to adapt the system components to achieve optimal visual output.

Special Clear Surfaces Patterns

Special patterns can be applied to clear surfaces such as glass surfaces.

The projectors system will project directly only onto the applied patterns allowing. This allows visibility or clear view based on requirements.

The patterns will based pattern density, size and viewers distance to screen either allow projections to be visible or invisible based on requirements.

The patterns size and features can change based on requirements and can be determined or adapted for optimal projection or by preprogramming from the computer or central server based or chosen be viewer, and determines with the computer which components to utilize and how to adapt the system components to achieve optimal visual output.

Shades

To enhance the projection from the projectors and allow the projections to be viewed in special environmental conditions such as strong external light sources or sun light, shades can be mounted onto the projectors or projection surface and projection screen canvas or both to create shadow that enables clear projections under the mentioned conditions.

These shades can be controlled to change angles based on the desired projection

These shades position in all angles (X,Y,Z) can be determined or adapted for optimal projection or by preprogramming from the computer or central server based or chosen be viewer, and determines with the computer which components to utilize and how to adapt the system components to achieve optimal visual output.

Sensors

Light Sensors

in order to control the projection output light sensors can control the lenses and mirrors

Motion Sensors

in order to find viewers location or projectors location and to determine with the computer which components to utilize and how to adapt the system components to achieve optimal visual output

Cameras

The Cameras can read the viewers location.

The Cameras can together with the projector calculate which part of the projection is being covered.

this is done by running the cameras input and visual feed to the projectors projections output and comparing them.

Cameras can Also

Face Detection

Cameras can read and recognize viewers face, body etc. either by video/footage analysis or by infrared, heat prints etc. to determine with the computer what media is best suitable and which components to utilize and how to adapt the system components to achieve optimal visual output.

In example Camera can switch off projections if a face is recognized looking into the projection source to avoid eye damage.

Text Detection/Image Detection

Camera can detect logos, age of viewer, clothes style, pets, babies, hair, colors etc, to determine with the computer what media is best suitable and which components to utilize and how to adapt the system components to achieve optimal visual output.

Direction Sensors

The direction sensors are either on the viewer or the projectors system or both.

They determine what the directions of projectors system projections are and/or viewers viewing direction, and which surface to be chosen for optimal projection or by preprogramming from the computer or central server or chosen be viewer, and determines with the computer what media is best suitable and which components to utilize and how to adapt the system components to achieve optimal visual output.

GPS

The GPS are either on the viewer or the projectors system or both.

GPS determines the projectors system projections are and/or and where viewers are viewing the projections, and which surface to be chosen for optimal projection or by preprogramming from the computer or central server or chosen be viewer, and determines with the computer what media is best suitable and which components to utilize and how to adapt the system components to achieve optimal visual output.

Distance Sensors

The distance sensors are either on the viewer or the projectors system or both.

Distance Sensors determine what the projectors system projections distance is and/or and what the viewers viewing the projections distance are, and which surface to be chosen for optimal projection or by preprogramming from the computer or central server or chosen be viewer, and determines with the computer what media is best suitable and which components to utilize and how to adapt the system components to achieve optimal visual output.

Angle Sensors

The angle sensors are either on the viewer or the projectors system or both.

Distance angle sensors determine what the projectors system projections angle is and/or and what the viewers viewing the projections viewing angle are, and which surface to be chosen for optimal projection or by preprogramming from the computer or central server or chosen be viewer, and determines with the computer what media is best suitable and which components to utilize and how to adapt the system components to achieve optimal visual output.

Position Sensors

The position sensors are either on the viewer or the projectors system or both.

Position Sensors determine what the projectors system projections position is and/or and what the viewers viewing the projections position are, and which surface to be chosen for optimal projection or by preprogramming from the computer or central server or chosen be viewer, and determines with the computer what media is best suitable and which components to utilize and how to adapt the system components to achieve optimal visual output.

Motion

The motion sensors are either on the viewer or the projectors system or both.

Motion Sensors determine what the projectors system projections motion is is and/or and what the viewers viewing the projections motions are, and which surface to be chosen for optimal projection or by preprogramming from the computer or central server or chosen be viewer, and determines with the computer what media is best suitable and which components to utilize and how to adapt the system components to achieve optimal visual output.

Computer

The Computers are either on the viewer or the projectors system or both.

Computer combines all system components.

Computer determine which of the projectors system components to utilize and how to adapt the system components to achieve optimal visual output.

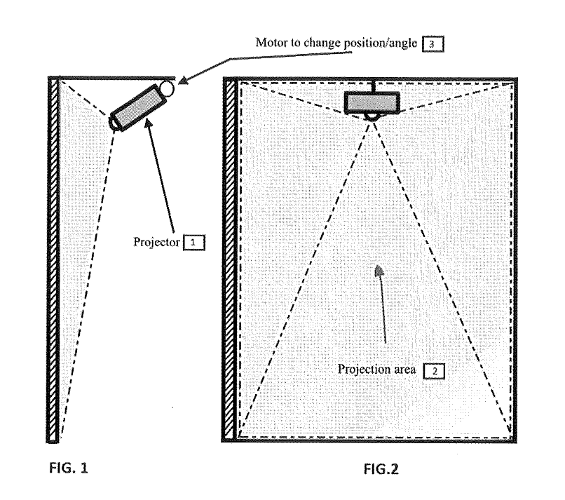

FIG. 1 illustrates an example where a projector [1] mounted onto an arm projects visual media onto canvas. The arm is connected to a motor [3] that can change projectors position to achieve best visual output.

Further the projection area [2] is illustrated that is projected onto referring to the present invention that all areas that are covered by light from the projection source regardless of angle of projection, can be adapted by computer in the projector to calculate projection to be as desired, even, visible and clear based on the projection area [2] surface.

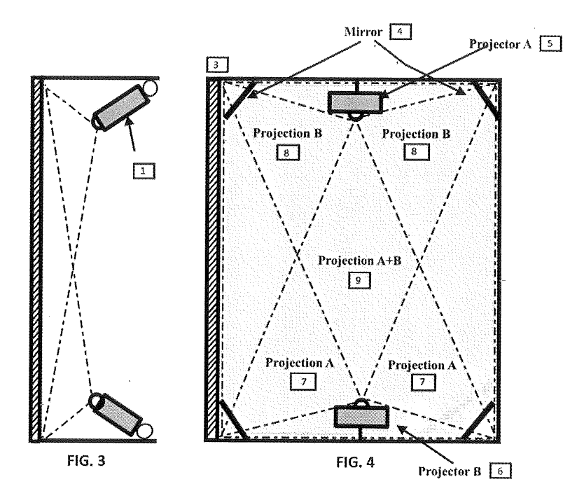

FIG. 2 illustrates FIG. 1 from a front perspective. FIG. 3 illustrates FIG. 4 from a side perspective.

FIG. 4 Illustrates an example where a larger projection area is desired and is created using multiple projectors [1] where a projector A [5] together with projector B [6] and together with mirrors and lenses [4] covers a larger projection area. Projector A & Projector B have each their own respective primary projection areas Projection A [7] & Projection B [8], that are mirrors/lenses [4] to expand and enhance the projections which further based on projector computer is calculated so that the visual output of projection A [7] & Projection B [8] and their combined projection area [9] becomes a desired clear visible and even visual output.

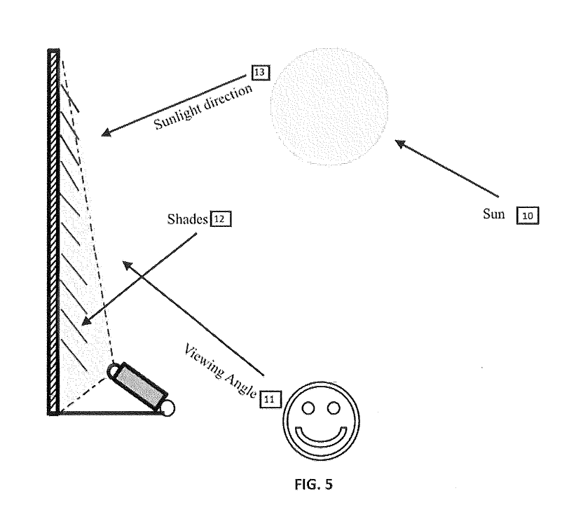

FIG. 5 illustrates how shades [12] that in this illustration are applied to the canvas or projection area creates shade from the environmental light i.e. sunlight [10] based on the directions of the light [13] while allowing projectors to project without being shaded based on viewing angle of [11] of users to allow a desired clear visible and visual output.

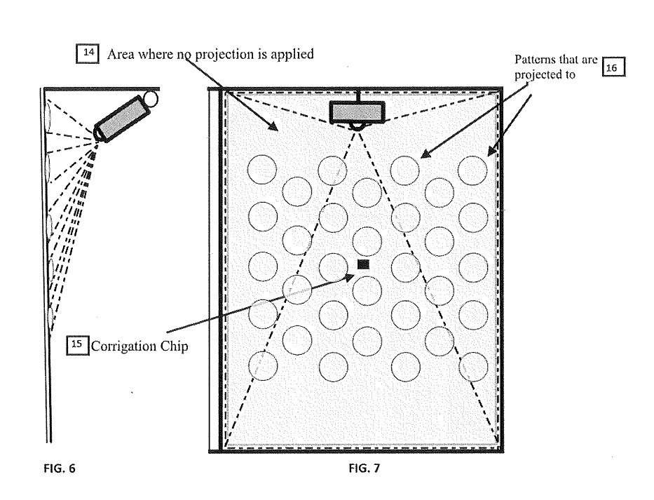

FIG. 6 illustrates FIG. 7 from a side perspective.

FIG. 7 illustrates how projectors [1] can project only onto a specific pattern applied to the projection area [16], within a broader projection area, leaving the rest of the projection area un-projected [14] allowing in this example a window to be projected onto at the same time letting the window be clear from one side of the window between the patterns, while creating a visible projection on the projected side of the window. Further a corrigation chip [15] can be used to aid the projection computer corrugate the projections based on calculations to achieve the desired clear, visible and even visual output.

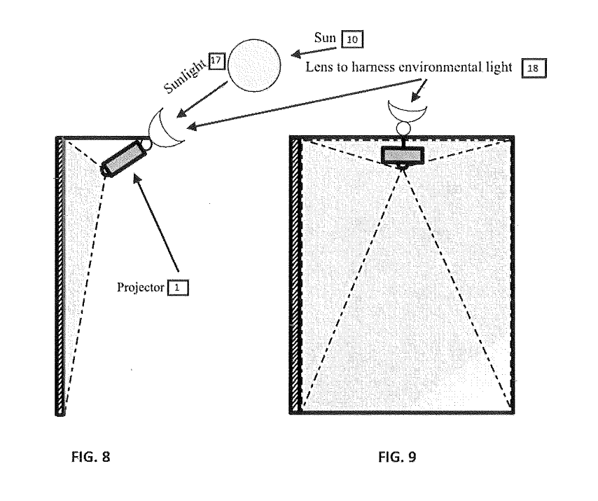

FIG. 8 illustrates how a projector [1] can harness the light, i.e. light from the sun [10] and channel i.e. sunlight [17] present in the environment where a visual projection is desired using a lens(es) [18] to harness and direct the light source to a digital light processing chip and create a visual projection or enforce the visual projection of the projector.

FIG. 9 illustrates FIG. 8 from a front perspective.

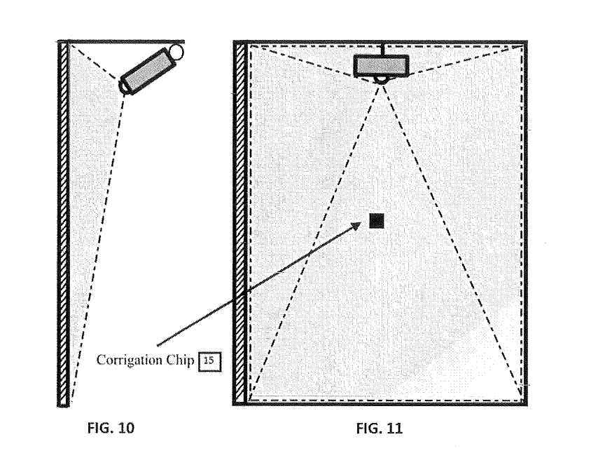

FIG. 10 illustrates an example where a corrigation chip [15] on the area of projection is used to corrugate and allow projectors to corrugate the projection the desired projection area by communicating with the projectors computers.

FIG. 11 illustrates FIG. 10 from a front perspective.

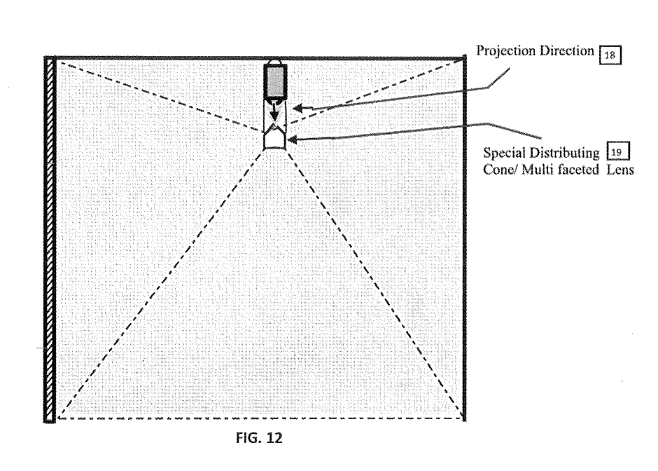

FIG. 12 illustrates an example where a projectors projection direction [18] is directed to a distribution lens [19] that distributes the projection from the projector in the desired angels and directions. In this illustration example the projection light is distributed to all walls of a room (360 degrees). Further the projector computer can based on calculations create the desired visual output for each direction and each segment from one single projectors projection on all surfaces desired.

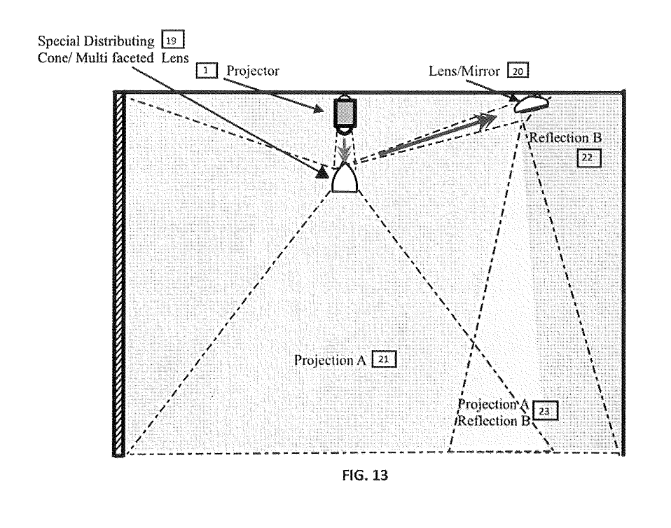

FIG. 13 illustrates an example where a projectors projection direction [18] is directed to a distribution lens [19] that distributes the projection from the projector in the desired angels and directions as well a lens/mirror [20] that further distributes, increases the projection area and enhances the projection.

The projectors computer will based on number of connected mirrors/lenses [20] to the system determine the projectors [1] projection output to create the desired visual projection display.

Further in this example Projection A [21] and reflection B [22] and projection A+ reflection B will be calculated by the projector computer with attention to the variables of the projection surface(s) such distance of from projectors to projection area, distance from projector to lens/mirror light strength of the projection towards Projection A and projection light strength towards Lens/mirror to project in such way that the desired even, clear and visible projection is achieved.

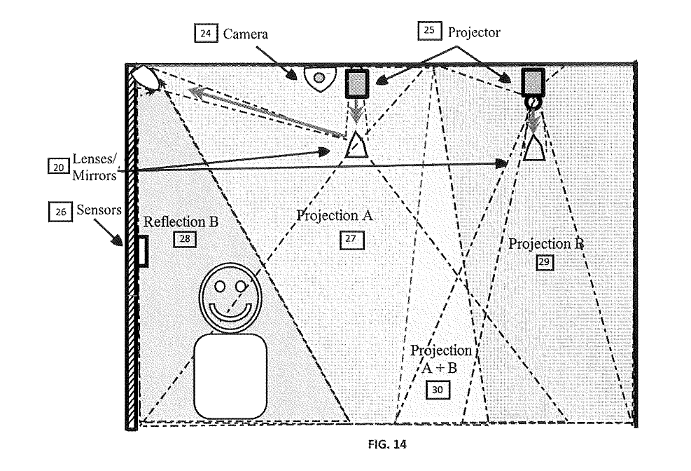

FIG. 14 illustrates an example of two projectors [25] project to distribution lenses [25] below the projectors and where one projectors further projects to a separate lens/mirror that further increases the total projection output that together with the projection computers adjusts and create the desired visual projection. A sensors [26] and a camera [24] is in this example illustrated to measure the users position and allow based on preprogramming or user control, based on variables such as in example users distance to screen, position, direction etc. to project the visual output desired.

1-10. (canceled)

11. A projection system comprising:
Projectors:
One or more projectors where the projectors angle towards the projection surface can be any angle towards the intended projection surface, as long as the entire surface of the projection area is covered by the light from the projector(s). Any projection light that would normally fall outside the desired projection area will not be projected onto, therefore no light will hit outside the desired projection surface in order to contain and limit the desired projection only within the desired projection surface.
Further the projectors can when required change the position in XYZ with the help of a motor.
Computer:
A computer that based on the angle of the projector and projection surface, adjust the image digitally by altering the image and/or mechanically with the by adjusting the mirrors/lenses in order to achieve the desired visual output on the projection surface.
Lens(s)/Mirror(s):
Lenses and mirrors will allow the projection system to further enhance the projection output in order to cover areas that can be projected to directly from the original projectors light output due to obstacles or persons that are blocking the way from the original source. The original projection source will in case beam a picture to the lens/mirrors that is further diverted via the lens/mirror system to the other side of the obstacles creating an even and clear image whether there is an obstacle or not. Further the lens/mirrors can when required change the position in XYZ with the help of a motor.
Receivers/transmitter:
Transmitter and receivers communicate between the computer and the projector, lens and mirrors allowing them to adapt visual media and projection output based on changes in the environment either in real time or based on preprogramming in order to achieve the desired visual projection output.

12. The projection system according to claim 11, further comprising:
Light sensors:
They determine what the directions of projectors system projections are and/or viewers viewing direction, and which surface to be chosen for optimal projection or by preprogramming from the computer or central server or chosen be viewer, and determines with the computer what media is best suitable and which components to utilize and how to adapt the system components to achieve optimal visual output.
GPS:
The GPS are either on the viewer or the projectors system or both.
GPS determines the projectors system projections are and/or and where viewers are viewing the projections, and which surface to be chosen for optimal projection or by preprogramming from the computer or central server or chosen be viewer, and determines with the computer what media is best suitable and which components to utilize and how to adapt the system components to achieve optimal visual output.
Distance sensors:
The distance sensors are either on the viewer or the projectors system or both.
Distance Sensors determine what the projectors system projections distance is and/or and what the viewers viewing the projections distance are, and which surface to be chosen for optimal projection or by preprogramming from the computer or central server or chosen be viewer, and determines with the computer what media is best suitable and which components to utilize and how to adapt the system components to achieve optimal visual output.
Position Sensors:
The position sensors are either on the viewer or the projectors system or both.
Position Sensors determine what the projectors system projections position is and/or and what the viewers viewing the projections position are, and which surface to be chosen for optimal projection or by preprogramming from the computer or central server or chosen be viewer, and determines with the computer what media is best suitable and which components to utilize and how to adapt the system components to achieve optimal visual output.

13. The projection system according to claim 12, further comprising:
Shades:
Shades that can be mounted onto the area of projection surface or projector positioning such that it creates shade that enables visibility of projection in high light ambient environment, sunshine, etc. by blocking the direction of the ambient environmental light adapting projections whilst allowing the light of the projection through the shades generating a visible projection onto desired area of projection.
Shades can change angle and size based on sensors or geographical data such as sunrise and sunset in the area of projection.

14. The projection system according to claim 12, further comprising:
Environmental Harnessing Lens:
The environmental harnessing lens(s) allow for the harnessing of the environmental ambient light on and around the projection area surface, i.e. sunlight, room light, light bulbs, etc., to be enhanced and directed via the projector(s) & lens and mirrors system, towards the projection surface either via the system projectors Digital Light Processing Chip or via its own stand-alone Digital Light Processing Chip to enforce, enhance the visual projection in order to create clear and visible images in ambient light environments, allowing the visual projections to equalize or be enforced the more ambient light increases.
Environmental harnessing light can be positioned in all angles and be adapted in all coordinates (X,Y,Z) that is determined for optimal projection by computer based on the data of the sensors and data from the other components and environmental data to meet and achieve best projection under the given environmental requirements.
Shades:
Shades that can be mounted onto the area of projection surface or projector positioning such that it creates shade that enables visibility of projection in high light ambient environment, sunshine, etc. by blocking the direction of the ambient environmental light adapting projections whilst allowing the light of the projection through the shades generating a visible projection onto desired area of projection.
Shades can change angle and size based on sensors or geographical data such as sunrise and sunset in the area of projection.

15. The projection system according to claim 12, further comprising:
A multifaceted lens:
A lens that distributed the light from the projection source to beam in all angles XYZ in 360 degrees, casting the projection light onto all surfaces of a 3 dimensional surrounding.

16. The projection system according to claim 12, further comprising:
Special Patterns:
Special patterns are applied to clear, transparent or opaque materials that is desired to be used as projection surface such as windows on a building, allowing for projection beam to be contained to these pattern such that each patterns will function as a pixel and create an image visible from a distance but avoiding beaming into a person's eyes.
The patterns can be applied to allow visibility on both side of the clear, transparent or opaque materials or from one side through the clear and transparent material, i.e. a window creating a visible projection on the one side of the widow whilst avoiding beaming into building.
Shades:
Shades that can be mounted onto the area of projection surface or projector positioning such that it creates shade that enables visibility of projection in high light ambient environment, sunshine, etc. by blocking the direction of the ambient environmental light adapting projections whilst allowing the light of the projection through the shades generating a visible projection onto desired area of projection.
Shades can change angle and size based on sensors or geographical data such as sunrise and sunset in the area of projection.

17. A projection system, comprising:
Projectors:
One or more projectors where the projectors angle towards the projection surface can be any angle towards the intended projection surface, as long as the entire surface of the projection area is covered by the light from the projector(s). Any projection light that would normally fall outside the desired projection area will not be projected onto, therefore no light will hit outside the desired projection surface in order to contain and limit the desired projection only within the desired projection surface.
Further the projectors can when required change the position in XYZ with the help of a motor.
Environmental Harnessing Lens
Where the environmental harnessing lens(s) allow for the harnessing of the environmental ambient light on and around the projection area surface, i.e. sunlight, room light, light bulbs, etc., to be enhanced and directed via the projector(s) & lens and mirrors system, towards the projection surface either via the system projectors Digital Light Processing Chip or via its own stand-alone Digital Light Processing Chip to enforce, enhance the visual projection in order to create clear and visible images in ambient light environments, allowing the visual projections to equalize or be enforced the more ambient light increases.
Environmental harnessing light can be positioned in all angles and be adapted in all coordinates (X,Y,Z) that is determined for optimal projection by computer based on the data of the sensors and data from the other components and environmental data to meet and achieve best projection under the given environmental requirements.

18. A projection system, comprising:
Adaptor
A apparatus that can be applied to existing light sources such a light bulbs, desk lamps, street lights etc. comprising:
Lens(s)/Mirror(s):
Lenses and mirrors will allow the projection system to further enhance the projection output The lens/mirrors can when required change the position in XYZ.
A Digital Light Processing Chip
That process the light directed by the existing light i.e. a desk lamp bulb and creates with the help of the lens to generate the desired visual projection output.

19. A projection system, comprising:
Projectors:
One or more projectors where the projectors angle towards the projection surface can be any angle towards the intended projection surface, as long as the entire surface of the projection area is covered by the light from the projector(s). Any projection light that would normally fall outside the desired projection area will not be projected onto, therefore no light will hit outside the desired projection surface in order to contain and limit the desired projection only within the desired projection surface.
Further the projectors can when required change the position in XYZ with the help of a motor.
Clear Surface Area of Projection System
Special patterns are applied to clear, transparent or opaque materials that is desired to be used as projection surface such as windows on a building, allowing for projection beam to be contained to these pattern such that each patterns will function as a pixel and create an image visible from a distance but avoiding beaming into a person's eyes.
The patterns can be applied to allow visibility on both side of the clear, transparent or opaque materials or from one side through the clear and transparent material, i.e. a window creating a visible projection on the one side of the widow whilst avoiding beaming into building.

20. A projection system, comprising:
Projectors:
One or more projectors where the projectors angle towards the projection surface can be any angle towards the intended projection surface, as long as the entire surface of the projection area is covered by the light from the projector(s). Any projection light that would normally fall outside the desired projection area will not be projected onto, therefore no light will hit outside the desired projection surface in order to contain and limit the desired projection only within the desired projection surface.
Further the projectors can when required change the position in XYZ with the help of a motor.
A multifaceted lens
A lens that distributes a projection to beam in all angles XYZ in 360 degrees, casting the projection light and visual media onto all surfaces of a 3 dimensional surrounding.
